(19) United States
(12) Patent Application Publication
(10) Pub. No.: US 2003/0013411 A1
(43) Pub. Date: Jan. 16, 2003

(54) Integrated cordless telephone and bluetooth dongle

(75) Inventor: Koji Uchiyama, Plantation, FL (US)

Correspondence Address: Daniel R. Brown, P.O. Box 821130, Fort Worth, TX, 76182-1130, US

(73) Assignee: Memcorp, Inc.

(21) Appl. No.: 09/904,629

(22) Filed: Jul. 13, 2001

(51) Int. Cl. H04B 13/02

(52) U.S. Cl. 455/40; 455/557; 455/465

(57) ABSTRACT

An integrated cordless telephone system and Bluetooth compliant dongle are taught. The cordless telephone operates in accordance with the Bluetooth specification in both of a voice communications and data communications mode of operation. In the data communications mode, a cordless handset portion of the cordless telephone is interconnected to a computing device and performs the function of a Bluetooth compliant dongle. Multiple cordless handset are supported within a single Bluetooth piconet, and thus the cordless telephone piconet can provide Bluetooth compliant wireless interconnectivity among a plurality of computing devices. In addition, telephony based features are implemented within certain computing devices by application of the present invention.

### BACKGROUND OF THE INVENTION

1. Field of the Invention

The present invention relates to telephones. More specifically, the present invention relates to cordless telephone systems that operate in accordance with the Bluetooth protocol standard.

2. Description of the Related Art

Cordless telephony is commonplace at the present time. Cordless telephones typically employ a base unit that is coupled directly to the public switched telephone network (“PSTN”) through a conventional telephone line. The communications signals transmitted and received to and from the PSTN are coupled though a radio transceiver in the cordless telephone base unit. A radio link is established to a corresponding radio transceiver in a cordless telephone handset. Within the cordless telephone handset, the received and transmitted radio signals are coupled to a microphone and earphone so as to form a user interface as is conventional in the art of telephony. The advantage of employing radio transceivers in a cordless telephone is to create a roaming area within which an end user is free to move about without the restrictions and limitation normally associated with a wired base/handset instrument.

As cordless telephony has evolved, a number of radio communications technologies and protocols have been employed by suppliers to achieve the radio linking of the base unit and the handset. Conventional analog AM and analog FM radio modulation have been employed. Frequency agility has been added to such conventional modulation schemes so that a number of different radio frequencies can be accessed by a given cordless telephone. With channel access management, such systems allowed a number of different users to share a limited pool of available radio channels. This approach can be characterized as a multiple access system.

More advanced techniques for multiple access in the radio environment have also been employed. Such techniques include frequency division multiple access (“FDMA”) and code division multiple access (“CDMA”) systems. Such systems have employed digital communications techniques where CODECs are employed to convert analog voice signals to digital, then back again. With the use of digital modulations schemes, as opposed to analog modulation schemes, time division multiple access (“TDMA”) protocols were developed and utilized. Various manufacturers developed such systems, and in many instances, the specifications and protocols employed were held proprietary to each manufacturer. Thus, there was seldom interoperability between various manufacturer's products, and even limited interoperability between different models from a single manufacturer.

In the same time frame as the aforementioned cordless telephony evolution occurred, the development of the personal computer industry also took place. A personal computer typically comprises a central processing unit, which is connected to one or more peripheral devices. These peripheral devices include a keyboard, a video display, a pointing device such as a mouse, a printer, a modem, loud speakers, microphones, mass storage devices, CD-ROM reader/writers, DVD reader/writers, and many other kinds of peripherals. As can readily be appreciated, a personal computer that is configured with a variety of peripheral devices will include a large number of interconnecting cables. With the advent of computer networking, the use of more interconnecting cables has occurred. In addition to this, there are a number of adjunct products that are used in association with computers. For example, personal digital assistants, personal organizers, MP3 audio players and so forth. While these devices operate in a stand-alone mode, it is commonplace for such devices to be interconnected to a personal computer for the transfer and synchronization of data between the personal computer, and one or more of these kinds of devices.

The advent of wireless communications, such as the cordless telephone, cellular telephones, and other wireless technologies and the advent of complex computer systems interconnected to a large number of peripheral devices as led to a complex environment that has numerous disadvantages. Among these is the general lack of interoperability, a complex number of kinds of interconnections, both wired and wireless, and a general increase in cost due to the duplication of technologies to solve such a broad array of interconnectivity issues. One approach to partially correcting this dilemma is the development and deployment of the Bluetooth standard.

Bluetooth is a recently developed communications standard for short-distance wireless interconnectivity. It is designed to replace wired connections, that would typically involve a variety of proprietary wiring specification, that interconnect devices and peripherals, with a single standardized short-range radio link. For instance, Bluetooth radio technology that is built into both a personal digital assistant and a personal computer can replace the cable used today to connect those two devices. Printers, personal computers, fax machines, keyboards, pointing devices, and virtually any other digital device can be part of the Bluetooth system. Bluetooth radio technology also provides a standardized bridge to existing data networks, peripheral device interfaces, and a mechanism to form small groupings of connected devices, which are called “piconets” in Bluetooth parlance.

The Bluetooth specification was developed by a joint industry group of leading wireless technology providers. Bluetooth technology is primarily intended for use in computing an telecommunications devices. It is designed for global application, and for both voice and data communications. The radio band employed in the United States for Bluetooth compliant devices is the ISM band the exists between 2.402 GHz and 2.480 GHz. That band is divided into 79 sub-bands. The Bluetooth compliant transceivers employs Continuously Variable Slope Delta Modulation (“CVSD”) voice coding in a frequency hopping spread-spectrum scheme. The hopping rate is 1600 hops per second, which greatly enhances noise immunity and performance, as is understood by those skilled in the art. The maximum data rate is approximately one megabit per second, however, transmissions are further managed depending of the service being supported. Flexible packet types can be specified and implemented for widely varying applications within the Bluetooth specification.

TDMA-like techniques are employed in the Bluetooth specification to provide different kinds of services within each channel. Two fundamental signaling approaches are employed, the first is a Synchronous Connection Oriented (SCO) connection and the other is an Asynchronous Connection-Less (ACL) approach which are used principally for voice and data communications respectively. More specifically, a single simplex or duplex voice communication session can be implemented with single 64 kilobits per second data stream. In a high speed data transfer mode, outbound data is send at 721 kilobits per second with inbound data sent at 57.6 kilobits per second, according to the Bluetooth specification. Up to three simultaneous voice communications session can exist on a single channel as well. Other arrangements are possible, see the Bluetooth specification which is available via the Internet at “http://www.bluetooth.com/developer/specification/core.asp”, the contents of which are hereby incorporated by reference thereto, and which are generally understood by those of ordinary skill in the art.

Suppliers of Bluetooth interface devices can implement the required circuitry within a product, such as a personal computer or one of the aforementioned peripheral devices. However, since there exists a tremendously large installed base of such equipment, for the near term, it is more likely that an adjunct product, which adds the Bluetooth wireless technology as a peripheral in and of itself, will be used. Such a device is called a Bluetooth “dongle”. A dongle is know to those skilled in the art as a device that attaches to a computer or other product to control or provide a particular interface or particular application. Typically, the dongle attaches to a personal computer's parallel port or serial port. The dongle couples all information through the port. It is possible to attach several dongles to the same port. In the case of a Bluetooth dongle, the dongle provides the Bluetooth interface and transceiver functionality when coupled with application specific software loaded onto the computer. The Bluetooth dongle is a product that must be purchased by a user in order to add Bluetooth wireless capability to an existing personal computer, or other wired device.

Suppliers of products that have access to Bluetooth technology also envision other product applications for the standard. For example, wireless headsets for a stereo system are envisioned. A Bluetooth dongle could be added to the audio output of a stereo system and then a pair of headsets that have a Bluetooth compliant receiver could drive earphones so that wireless operation could be implemented. Similarly intercom systems and cordless telephones could be implemented utilizing Bluetooth compliant components, rather than a proprietary transceiver systems. However, in such an environment, a single user may acquire various Bluetooth compliant devices and thereby have cumulative Bluetooth products beyond what could be essential to achieve the desired wireless functionality. This implies added expense and the accumulation of unnecessary products. Thus, there is a need in the art for system and method to integrate Bluetooth functionality where possible.

### SUMMARY OF THE INVENTION

The need in the art is addressed by the apparatus and methods of the present invention. The present invention teaches a cordless telephone with Bluetooth compatibility. One embodiment includes a cordless telephone transceiver and a Bluetooth circuit coupled to it. Also, a serial port which is also coupled to the Bluetooth circuit. The Bluetooth circuit is operable to couple serial data between the serial port and the cordless telephone transceiver, thereby communicating the serial data according to the Bluetooth radio communications protocol. In a refinement of this embodiment, the serial communications port is a Universal Serial Bus (USB) compliant serial port. In another refinement of this embodiment, the cordless telephone includes an accessory software program executable on a separate computing device that enables the coupling of data signals between the separate computing device and the Bluetooth circuit. This is done though the serial port and is for coupling the data signals via the Bluetooth radio communications protocol by the cordless telephone transceiver to other devices. In a further refinement of this embodiment, the cordless telephone includes a memory for storing user data that is coupled to the Bluetooth circuit, and the Bluetooth circuit operable to couple data signals with the memory. Also included is an accessory software program that is executable on a separate computing device for synchronizing data stored in the separate computing device with user data stored in the memory via the serial port while the separate computing device is coupled to the serial port.

In another embodiment of the present invention, an integrated Bluetooth dongle and cordless telephone are taught. This device includes an audio circuit that has an audio signal interface coupled to a microphone and an earphone. Also, a serial port, and a Bluetooth circuit coupled to the audio signal interface that is operable to convert between conventional audio signals and Bluetooth compliant audio signals. In addition, the Bluetooth circuit has a communications interface coupled to the serial port and is operable to convert between conventional serial data signals and Bluetooth compliant data signals. The device also has a cordless telephone transceiver coupled to the Bluetooth circuit and is operable to communicate the Bluetooth compliant audio signals and Bluetooth compliant data signals according to the Bluetooth radio communications protocol. In a refinement of this embodiment, the serial communications port is a Universal Serial Bus (USB) compliant serial port. In another refinement of this embodiment, the device further includes a software program executable on a separate computing device that enables the coupling of data signals between the separate computing device and the Bluetooth circuit. This occurs though the serial port and is for coupling the data signals via the Bluetooth radio communications protocol by the cordless telephone transceiver. In another refinement of this embodiment, the device further includes a memory for storing user data that is coupled to the Bluetooth circuit. And, the Bluetooth circuit operable to couple data signals with the memory. An accessory software program is included, which runes on a separate computing device and is used to synchronize data stored in the separate computing device with user data stored in the memory. This is done via the serial port while the separate computing device is coupled to the serial port.

In another embodiment of the present invention, an integrated Bluetooth cordless telephone is taught. This device includes a cordless telephone handset, which further includes an audio circuit that has an audio signal interface coupled to a microphone and an earphone. Also, a serial port, and a first Bluetooth circuit coupled to the audio signal interface that is operable to convert between conventional audio signals and Bluetooth compliant handset audio signals. The Bluetooth circuit has a communications interface coupled to the serial port and operates to convert between conventional serial data signals and Bluetooth compliant data signals. Also, a first cordless telephone transceiver coupled to the Bluetooth circuit that operates to communicate the Bluetooth compliant handset audio signals and Bluetooth compliant data signals according to the Bluetooth radio communications protocol. This embodiment also includes a cordless telephone base unit, which further includes a telephone line interface circuit for coupling to a telephone line. And, a second Bluetooth circuit coupled to the telephone line interface that operates to convert between conventional telephony signals and Bluetooth compliant base unit audio signals. Also, a second cordless telephone transceiver coupled to the Bluetooth circuit that operates to communicate the Bluetooth compliant base unit audio signals according to the Bluetooth radio communications protocol. In operation, the cordless telephone handset and the cordless telephone base unit communicate audio and data information according to the Bluetooth protocol.

The foregoing embodiment is further refined by using a USB serial port for the aforementioned serial port. In another refinement, the device further includes an accessory software program that is executable on a separate computing device enabling the coupling of data signals between the separate computing device and the first Bluetooth circuit. This is accomplished though the serial port and is used for coupling the data signals via the Bluetooth radio communications protocol by the first cordless telephone transceiver. In a further refinement, the device also includes a memory for storing user data coupled to the first Bluetooth circuit. Also, the first Bluetooth circuit operable to couple data signals with the memory. The device also includes an accessory software program executable on a separate computing device for synchronizing data stored in the separate computing device with user data stored in the memory via the serial port while the separate computing device is coupled to the serial port.

### BRIEF DESCRIPTION OF THE DRAWINGS

FIG. 1 is a diagram of a Bluetooth piconet utilizing am illustrative embodiment of the present invention.

FIG. 2 is a drawing of a cordless telephone handset according to an illustrative embodiment of the present invention.

FIG. 3 is a drawing of a cordless telephone base unit according to an illustrative embodiment of the present invention.

FIG. 4 is a functional block diagram of a cordless telephone base unit according to an illustrative embodiment of the present invention.

FIG. 5 is a functional block diagram of a cordless telephone handset according to an illustrative embodiment of the present invention.

FIG. 6 is a functional diagram of the interface between a computer and a cordless telephone/dongle device according to an illustrative embodiment of the present invention.

FIG. 7 is a functional diagram of a device interface scheme according to an illustrative embodiment of the present invention.

FIG. 8 is a functional diagram of a device interface scheme according to an illustrative embodiment of the present invention.

embodiment of the present invention.

### DESCRIPTION OF THE INVENTION

Illustrative embodiments and exemplary applications will now be described with reference to the accompanying drawings to disclose the advantageous teachings of the present invention. While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

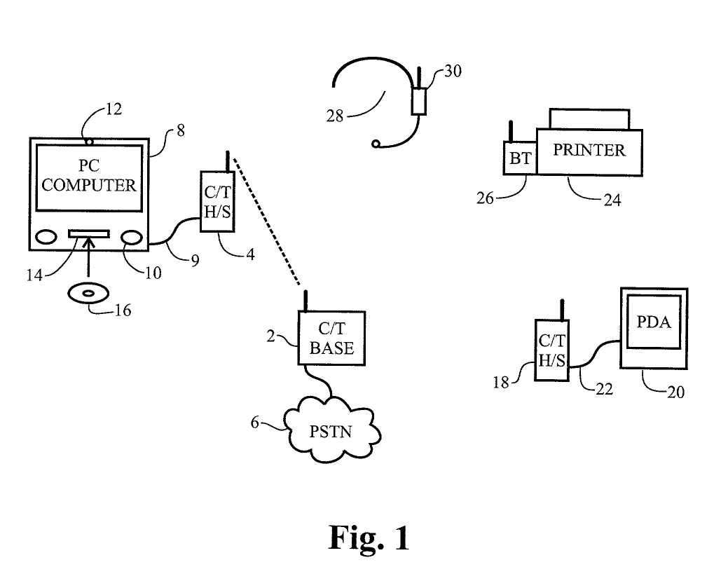

An illustrative embodiment of the present invention is illustrated in FIG. 1. Generally speaking, FIG. 1 shows a personal area network (“PAN”). Within this PAN is a personal computer 8, a cordless telephone base unit 2, a first cordless telephone handset unit 4, a second cordless telephone handset 18, a personal digital assistant 20, and a printer 24. The integrated cordless telephone and Bluetooth dongle according to the present invention is embodied by both of the cordless telephone handsets 4 and 18.

The cordless telephone base unit 2 operates according to the Bluetooth protocol and is capable of transmitting and coupling both Bluetooth audio and Bluetooth data compliant signals. In a conventional cordless telephone mode of operation, the cordless base unit 2 communicates audio signals coupled to the base unit 2 from the public switched telephone network (“PSTN”) 6 to the first cordless handset 4, as is indicated by the broken line between these two drawing objects in FIG. 1. The interface to the PSTN 6 is accomplished in any of the traditional manners, via an RJ-11 interface for example. The cordless base unit 2 converts the analog audio signals to Bluetooth compliant audio signals and couples them via Bluetooth radio signals to the cordless handset 4. In a typical application, this would involve 64 kpbs duplex audio using an SCO path. Of course, other Bluetooth compliant paths could be used if necessary. The cordless handset 4 completes the path by coupling the Bluetooth compliant radio signals and converting them to a conventional telephony user interface, including a microphone and an earphone. Thus, a user can access the cordless handset 4 to engage in a telephone conversation with another use somewhere in the PSTN, by coupling the signals over the PAN according to the Bluetooth specification.

Another advantage of the present invention is also illustrated in FIG. 1. Cordless handset 4 includes an interface port to which interconnecting cable 9 is coupled. The other end of the coupling cable 9 connects to a similar port on personal computer 8. In an illustrative embodiment of the present invention, these ports are serial data communications ports. In another illustrative embodiment, they are ports compliant with the Universal Serial Bus interface standard (“USB”) which is preferred and understood by those having ordinary skill in the art. The cordless base unit 2 and the cordless handset 4 are compliant with the Bluetooth data communications features as well as the audio communications features. When operating in the data transfer mode, the cordless telephone advantageously provides the function of a Bluetooth dongle, as well as other advantages and features, as will be discussed more fully hereinafter. In one application of this feature, telephone directory and personal information data that is stored in the cordless base unit 2 and/or the cordless handset 4 can be transferred, updated, and synchronized with similar data stored in a memory or mass storage device associated with personal computer 8. The implementation of such transfers, updating, and synchronization requires a specific application software program to be resident in the personal computer 8. This is provided with the cordless telephone 2, 4 in the form of a CD-ROM 16 which allows the user to load such programs into the personal computer 8 via an internal CD-ROM drive 14. Of course, those of ordinary skill in the art will appreciate that the program could be loaded into the computer by any of the currently available or yet to be developed means. For example, floppy disk, CD-ROM, DVDROM, Internet transfer, private network transfer, flash memory cards, or other interconnection of mass storage device.

Yet another aspect and advantage of the present invention is illustrated in FIG. 1. In addition to the aforementioned data transfer function between cordless handset 4 and personal computer 8 over cable 9, is the ability to transfer digitized audio signals therebetween. Additional software operating on personal computer 8 couples the digitized audio and converts it into analog audio signals that are coupled to loudspeakers 10 and microphone 12 in personal computer 8. Such loudspeakers and microphones are prevalent in modern personal computers. In this mode of operation, the application of the cordless handset 4 as Bluetooth dongle is advantageously utilized to transform the personal computer into a telephone terminal device.

Those of ordinary skill in the art and access to the teachings herein will appreciate that either of the cordless handset 4 or cordless base unit 2 can act as a master unit or a slave unit in a Bluetooth piconet PAN. Such networking capability opens a large number of possible topologies and services. In an illustrative embodiment of the present invention, a plurality of cordless handset units can operate within the piconet. For example, the second cordless handset 18 in FIG. 1 can communicate with either of the base unit 2 in a cordless telephone function, or it can communicate directly with the first cordless handset 4 in an intercom mode. Both of these modes utilizing the Bluetooth audio data protocol standards. However, since each of the first and second cordless handsets 4 and 18 both have the aforementioned interface port, the units can communicate utilizing the Bluetooth data communications protocols to act as dual dongles and thereby enable data communications between devices. In FIG. 1, the second cordless handset is interface to a personal digital assistant (“PDA”) 20 via interconnecting cable 22, which couples to communications ports on the two devices. In this arrangement, data and information can be transferred between the PDA 22 and the personal computer 8, through the first and second cordless handsets 4 and 18. By utilizing these teachings, the cordless telephones provide not only the telephone functions, but also extended telephone functions, as well as Bluetooth dongle functionality without the need for a user to purchase separate Bluetooth dongles for the personal computer and PDA, in this illustrative embodiment.

Again, considering FIG. 1, there are other capabilities in the illustrative embodiment of the present invention. A Bluetooth compliant headset 28 can be used to communicate duplex audio according to the Bluetooth audio protocols by employing a Bluetooth circuit 30 in the headset 28. The headset 28 communicates directly with the cordless base unit 2 according to the Bluetooth audio protocols. This feature provides hands-free mobility for a user of the present invention. Also, once the first cordless handset 4 has been coupled to the personal computer 8, any Bluetooth compliant device within the piconet is enabled to communicate with the computer. In FIG. 1, a printer 24 that has its own Bluetooth dongle 26 (or that has built-in Bluetooth circuitry) can be radio coupled to the personal computer 8 and operate according to the Bluetooth data protocols.

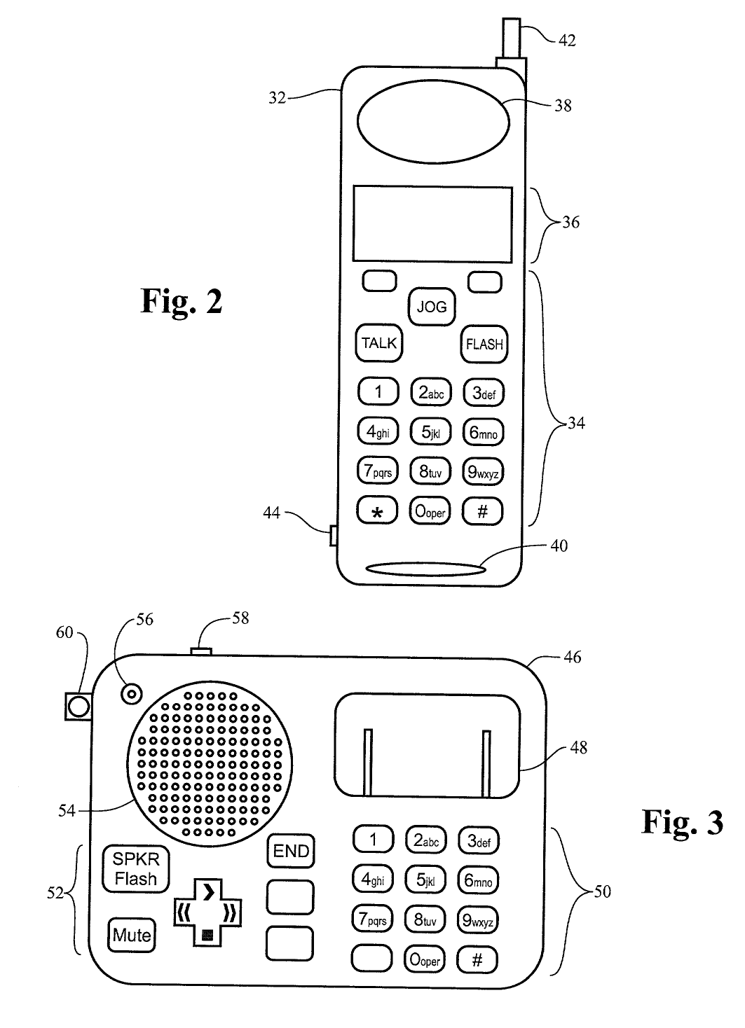

Reference is directed to FIG. 2, which is an illustrative embodiment cordless telephone handset 32 according to the teachings of the present invention. The user interface comprised a conventional keypad 34 that enables the user to dial telephone numbers, select other devices in the piconet, and control other related functions of the present invention. It also comprises a display 36 that serves to advise the user of various operational features, as are understood by those skilled in the art, as well as the present invention Bluetooth integration features. The user interface also includes the customary earphone 38 and microphone 40, as are understood by those of ordinary skill in the art. An antenna 42 radiates and receives Bluetooth compliant radio signals to and from the cordless handset 32. The serial port connector 44 is exposed on the exterior of the handset 32, as well. As was noted above, a USB port interface is utilized in the preferred embodiment, however, those skilled in the art will appreciate that any data communications interface standard, whether public or private could be utilized.

Reference is directed to FIG. 3, which is an illustrative embodiment cordless telephone base unit 46 according to an illustrative embodiment of the present invention. The base unit 46 includes a traditional charging cradle 48 with electrical contacts (not numbered) for recharging the handset battery while the handset rests on the cradle 48. The base unit 46 also includes a standard telephone numeric keypad 50 that is used to dial telephone numbers and to enter numeric data and to select certain functions. In addition, there is a function keypad 52 that allows the user to select various features of the device and systems. In this illustrative embodiment, there is a speakerphone function built into the base unit. The implementation of this feature is accomplished by using a loudspeaker/microphone 54. This feature allows the user to employ a speaker phone feature to the PSTN as well as with handset units in the piconet, or other Bluetooth compliant audio devices within the piconet. The base unit 46 in this illustrative embodiment also includes an interface port 58 that provides the same wired interface capabilities mentioned respecting the handsets. Thus, the base unit 46 can act as a Bluetooth dongle in the same fashion as a handset unit. The base unit 46 also includes an antenna for coupling Bluetooth compliant radio signals, and an indicator lamp 56 which is used for a variety of function in the cordless telephone systems.

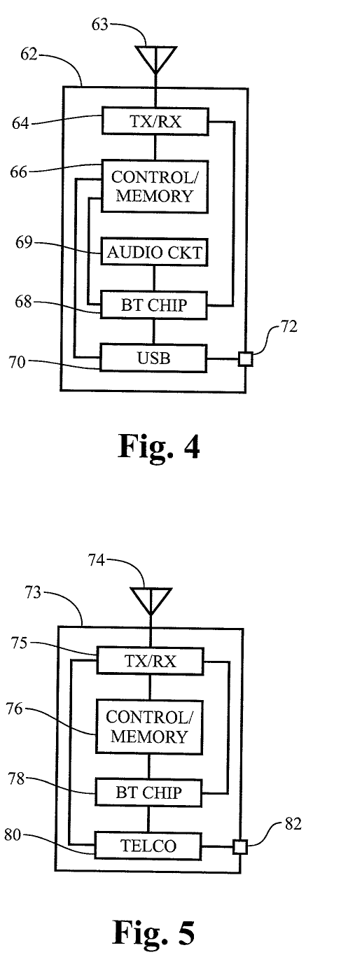

Reference is directed to FIG. 4, which is a functional block diagram of a cordless telephone handset 62 according to an illustrative embodiment of the present invention. A Bluetooth compliant transceiver 64, which provides duplex transmission and reception capabilities, is coupled to an antenna 63, which is a radio signal radiating and receiving structure. The transceiver 64 is coupled to, and partially under the control of, a controller 66. The controller 66 may be any of a variety of processors, microprocessors, and signal processors as are understood by those skilled in the art. A memory function is a part of the controller 66. A Bluetooth chip 68 is utilized in this illustrative embodiment, however any suitable Bluetooth circuit topology would suffice, whether implemented primarily as software or hardware, that is presently available or that later becomes available. The Bluetooth chip 68 serves to convert conventional audio and data signal into Bluetooth compliant audio and data signals according to the aforementioned Bluetooth specification. In addition to data conversation, the Bluetooth chip 68 implements the requisite Bluetooth control protocols, including access, management, formatting, and protocol selection. The Bluetooth chip 68 is coupled to the transceiver 64, and together these devices generate and decode Bluetooth compliant radio signals. The Bluetooth chip 68 is also coupled to the controller 66 so as to coordinate the control of other devices and implementation of the features of the present invention, including user interface management. An audio circuit 69 is coupled to the Bluetooth chip 68 and receives the decoded audio information from the Bluetooth chip 68 and converts them for use in the user interface. In this illustrative embodiment, the audio circuit 69 includes a microphone and earphone. In the preferred embodiment, a USB port interface circuit 70 is coupled to the Bluetooth chip 68. Bluetooth compliant data signals are converted to conventional data signals by the Bluetooth chip 68 and the USB port 70 formats this data according to the USB specification for coupling to a device external to the handset 62 as was discussed above. Such coupling is accomplished through USB connector 72. The controller 66 is also coupled to the USB port 70 to further manage port activity and the transfer of data form the memory 66 in controller 66 out the connector 72.

Reference is directed to FIG. 5, which is a functional block diagram of an illustrative embodiment cordless telephone base unit 73 according to the present invention. Bluetooth compliant radio signals are received and radiated by antenna 74, which is coupled to a Bluetooth compliant transceiver 75. The transceiver 75 is coupled to a controller 76 and to a Bluetooth chip 78. The Bluetooth chip 78 is utilized in this illustrative embodiment, however any suitable Bluetooth circuit topology would suffice, whether implemented primarily as software or hardware, that is presently available or that later becomes available. The Bluetooth chip 78 serves to convert conventional audio and data signals into Bluetooth compliant audio and data signals according to the aforementioned Bluetooth specification. In addition to data conversation, the Bluetooth chip 78 implements the requisite Bluetooth control protocols, including access, management, formatting, and protocol selection. As noted, the Bluetooth chip 78 is coupled to the transceiver 75, and together these devices generate and decode Bluetooth compliant radio signals. The Bluetooth chip 78 is also coupled to the controller 76 so as to coordinate the control of other devices and implementation of the features of the present invention, including user interface management. A telephone line interface 80 is provided in the base unit 73. The telephone line interface 80 is coupled to the PSTN via an interface connector 82, which is an RJ-11 jack in this illustrative embodiment. The telephone line interface 80 couples conventional telephone audio and call progress signals to the Bluetooth chip 78 where they are reformatted to the Bluetooth audio and data protocols. In addition, the telephone line interface 80 is coupled to the controller 76 for call progress and other feature management. The controller 76 may be any of a variety of processors, microprocessors, and signal processors as are understood by those skilled in the art. A memory function is a part of the controller 76. The controller 76 serves to run executable code that embodies the features and functions of the illustrative embodiment. As was discussed earlier, the base unit 73 comprises all of the serial port interface functionality of the handset unit in another illustrative embodiment of the present invention. While these functions are not illustrated in FIG. 5, they are essentially the same as illustrated in the handset in FIG. 4.

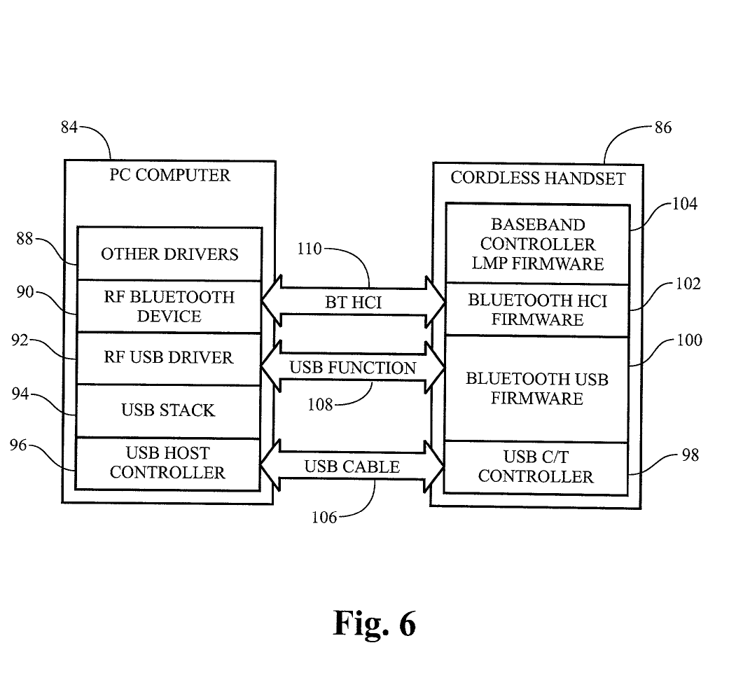

Reference is directed to FIG. 6, which illustrates the various interface relationships between a personal computer 84 and the present invention cordless telephone 86 when they are interconnected as discussed herein before. At the physical level, the personal computer 84 employs a USB host controller 96 to communicate with a similar USB controller 98 in the cordless telephone, which occurs via a USB cable 106. Within the personal computer 84 is a USB controller stack 94 that provides a software control interface to the USB host controller 96, as is understood by those of ordinary skill in the art. Above the USB Stack 94, is an RF USB driver 92 that provides control and direction of the stack 94 and controller 96. The particular functions, described herein before, are implemented at level 90 as the RF Bluetooth device driver module in the software. As is understood by those skilled in the art, the Interface stack coordinates hardware and software operations at multiple levels. Thus, in the cordless handset 86, which is operating as a Bluetooth dongle during the session described here, couples the USB functionality from the RF USB driver 92 in the personal computer 84 with Bluetooth USB firmware 100 stored in a memory in the cordless handset 86. The USB function interface 108 is not a physical interface, but is a functional interface in managing the USB session between the two physical devices. At the level above this, the Bluetooth host controller interface functional coupling 110 occurs. This communications occurs between the RF Bluetooth device application 90 in the personal computer 84 and the Bluetooth host controller interface firmware 102 in the cordless handset 102. Finally, in the personal computer, another layer in the protocol stack occurs for supporting other devices, device drivers 88, that may interface through the Bluetooth dongle implementation described here. In the cordless handset 86, the upper layer is a baseband link manager protocol controller 104, which is implemented as firmware in the cordless handset. Those of ordinary skill in the art and access to the teachings herein and the Bluetooth specification incorporated by references will appreciate this as a variation of a convention ISO stack model.

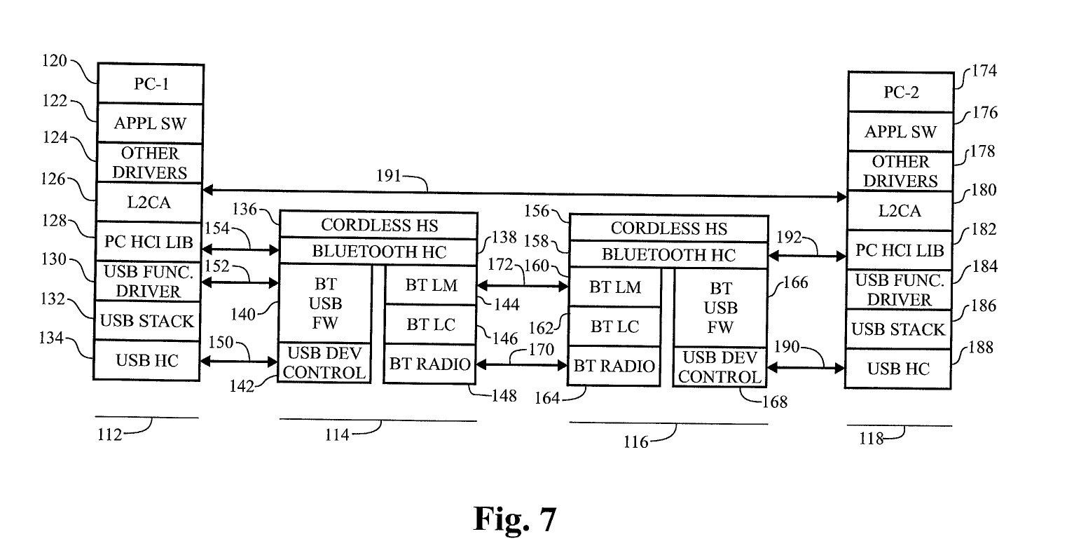

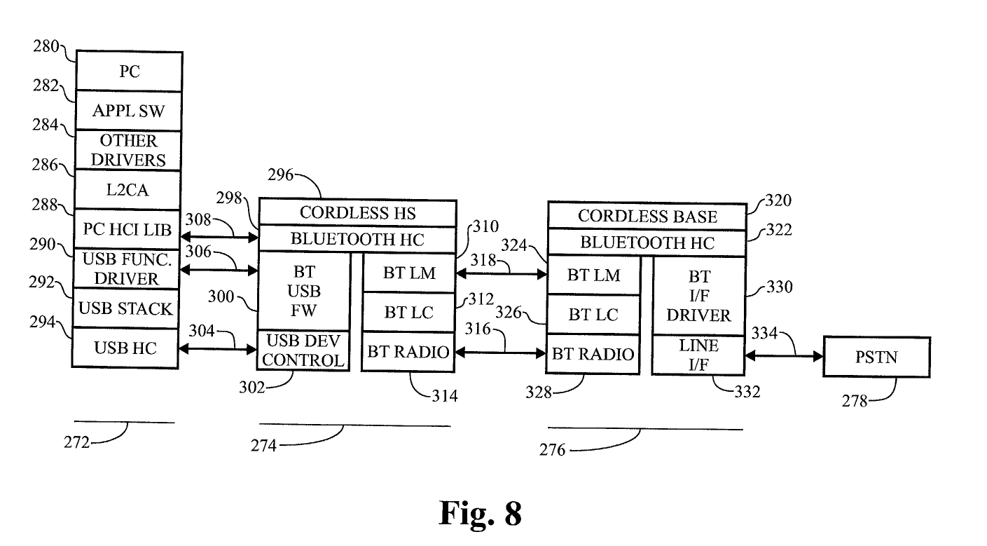

Now, expanding the protocol stack perspective view of the present invention, which is useful for those skilled in the art to appreciate the techniques for implementing the present invention, attention is directed to FIG. 7. FIG. 7 is a functional diagram of the interface between two computing devices through a pair of cordless handset according to an illustrative embodiment of the present invention. FIG. 7 generally comprises four physical devices, a first computing device 112, a first cordless handset 114, a second cordless handset 116, and a second computing device 118. The respective first computing device 112 and first cordless handset 114 are physically interconnected by a USB cable 150. Similarly, the respective second cordless handset 116 and second computing device 118 are physically interconnected by a USB cable 190. The first cordless handset 114 and the second cordless handset are interconnected with a Bluetooth compliant radio signal 170. The first computing device stack begins at the lowest level, the physical level, with a USB host controller 134. Above that is the aforementioned USB stack 132, and above that the USB functional driver 130, which is implemented in software in the computing device 112. Above the functional driver 130 is a host controller library 128 the provides functions to the driver 130 below. At the next level is the Bluetooth logical link control and management element 126, also the bus driver, of the protocol stack. Finally, within the first computing device are other drivers 124 for interfacing with the Bluetooth functionality, and application level software 122 for the personal computer 120.

Continuing with FIG. 7, The functions within the first cordless telephone 114 are discussed. At the physical interface, (via USB cable 150) with the first computing device 114 is the USB device and control module 142. Above that is the Bluetooth USB firmware 140, which functionally couples 152 with the USB functional driver 130 in the computing device. Above that are the USB host controller functions 138 that couple with the host controller interface library 128 in the computing device 112. At the highest level is the cordless telephone functions 136 that embody all the other operation features and functions of the first cordless telephone 114. Moving back down the protocol stack toward the physical Bluetooth radio interconnection, is the Bluetooth link manager module 144. Below that is the Bluetooth link controller 146 that directly controller the Bluetooth radio 148 functions. A radio link 170 is made to the second cordless handset 116. The functional stack in the second cordless handset 170 are identical to those in the first. Briefly, they are, the Bluetooth radio module 164, coupled to the Bluetooth link controller 162, coupled to the Bluetooth link manager 160. Note that the Bluetooth link manager 160 in the second cordless handset 116 functionally couples to the Bluetooth link manager 144 in the first cordless handset 114. Continuing, the Bluetooth host controller 158 and other cordless handset function 156 complete the high level functions in the second cordless handset 116. Going back down to the USB physical interface are the Bluetooth USB firmware 166 and USB device and control 168 which are coupled to the second computing device 118 via a USB cable 190. The second computing device 118 is the same as the first, in this illustrative embodiment, and comprises the USB controller and host 188, which couples to the USB stack 186. Above that, the USB functional driver 184 and the computing device host controller interface 182 that functionally couples with the Bluetooth host controller in the second cordless handset 116. Continuing, is the logical link control and management module 180. The logical link control module 180 functionally couples to the same module 126 in the first computing device to establish the functional link between the two computing devices. Again continuing, the other drivers 178, other application software 176 and the computing device itself at 174 complete the functional stack. Thus, a communications session for coupling either Bluetooth compliant audio or data can be established between two separate computing device according to this illustrative embodiment of the present invention. Those of ordinary skill in the art will appreciate that the computing devices can be any of a variety of computing devices, such as computers, personal computers, personal digital assistants, computer controller equipment, or any other computing device now available or later contemplated.

Reference is directed to FIG. 8, which illustrates the functional relationship of an interconnection between a computing device 272, through a cordless handset 274 and a cordless base unit 276 though to the PSTN 278. The computing device 272 and the cordless handset 274 are physically coupled by a USB cable 304. The cordless handset 274 and the cordless base unit 276 are physically coupled by Bluetooth compliant radio signals 316. The cordless base unit 276 and the PSTN are physically coupled by a twisted pair cable 334 in this illustrative embodiment. The computing device stack begins at the lowest level, the physical level, with a USB host controller 294. Above that is the aforementioned USB stack 292, and above that the USB functional driver 290, which is implemented in software in the computing device 272. Above the functional driver 290 is a host controller library 288 the provides functions to the driver 290 below. At the next level is the Bluetooth logical link control and management element 286, also the bus driver, of the protocol stack. Finally, within the computing device 272 are other drivers 284 for interfacing with the Bluetooth functionality, and application level software 282 for the computer 280. The functions within the cordless telephone 274 are discussed. At the physical interface, (via USB cable 304) with the computing device 272 is the USB device and control module 302. Above that is the Bluetooth USB firmware 300, which functionally couples 306 with the USB functional driver 290 in the computing device. Above that are the USB host controller functions 298 that couple 308 with the host controller interface library 288 in the computing device 272. At the highest level are the cordless telephone functions 296 that embody all the other operation features and functions of the cordless telephone 274. Moving back down the protocol stack toward the physical Bluetooth radio interconnection, is the Bluetooth link manager module 310. Below that is the Bluetooth link controller 312 that directly controller the Bluetooth radio 314 functions. A radio link 316 is made to the cordless base unit 276.

Continuing with a description of FIG. 8, the cordless base unit 276 functionally comprises a Bluetooth radio module 328 at the physical level of the stack. Above that is the Bluetooth link controller module 326 and above that, the Bluetooth link manager module 324 that functionally couples with the similar module in the cordless handset 274. The Bluetooth host controller function 322 and cordless base unit function 320 form the upper most logical stack elements, Going toward the physical telephony interface is a Bluetooth interface driver 330 and a telephone line interface 332, which couples via twisted pair 334 to the PSTN 278, in thus illustrative embodiment.

Thus, the present invention has been described herein with reference to a particular embodiment for a particular application. It is therefore intended by the appended claims to cover any and all such applications, modifications and embodiments within the scope of the present invention.

Accordingly,

What is claimed is:

1. An apparatus, comprising:
a cordless telephone transceiver;
a Bluetooth circuit coupled to said cordless telephone transceiver;
a serial port coupled to said Bluetooth circuit, and
wherein said Bluetooth circuit is operable to couple serial data between said serial port and said cordless telephone transceiver, thereby communicating said serial data according to the Bluetooth radio communications protocol.

2. The apparatus in claim 1, and wherein said serial communications port is a Universal Serial Bus compliant serial port.

3. The apparatus of claim 1, further comprising a software means executable on a separate computing device enabling the coupling of data signals between said separate computing device and said Bluetooth circuit, though said serial port, for coupling said data signals via the Bluetooth radio communications protocol by said cordless telephone transceiver.

4. The apparatus of claim 1, further comprising:
a memory for storing user data coupled to said Bluetooth circuit, said Bluetooth circuit operable to couple data signals with said memory, and
a software means executable on a separate computing device for synchronizing data stored in said separate computing device with user data stored in said memory via said serial port while said separate computing device is coupled to said serial port.

5. An integrated Bluetooth dongle and cordless telephone, comprising:
an audio circuit, having an audio signal interface coupled to a microphone and an earphone;
a serial port;
a Bluetooth circuit coupled to said audio signal interface and operable to convert between conventional audio signals and Bluetooth compliant audio signals, said Bluetooth circuit having a communications interface coupled to said serial port and operable to convert between conventional serial data signals and Bluetooth compliant data signals, and
a cordless telephone transceiver coupled to said Bluetooth circuit, and operable to communicate said Bluetooth compliant audio signals and Bluetooth compliant data signals according to the Bluetooth radio communications protocol.

6. The apparatus in claim 5, and wherein said serial communications port is a Universal Serial Bus compliant serial port.

7. The apparatus of claim 5, further comprising a software means executable on a separate computing device enabling the coupling of data signals between said separate computing device and said Bluetooth circuit, though said serial port, for coupling said data signals via the Bluetooth radio communications protocol by said cordless telephone transceiver.

8. The apparatus of claim 5, further comprising:
a memory for storing user data coupled to said Bluetooth circuit, said Bluetooth circuit operable to couple data signals with said memory, and
a software means executable on a separate computing device for synchronizing data stored in said separate computing device with user data stored in said memory via said serial port while said separate computing device is coupled to said serial port.

9. An integrated Bluetooth cordless telephone, comprising:
a cordless telephone handset, further comprising:
an audio circuit, having an audio signal interface coupled to a microphone and an earphone;
a serial port;
a first Bluetooth circuit coupled to said audio signal interface and operable to convert between conventional audio signals and Bluetooth compliant handset audio signals, said Bluetooth circuit having a communications interface coupled to said serial port and operable to convert between conventional serial data signals and Bluetooth compliant data signals;
a first cordless telephone transceiver coupled to said Bluetooth circuit, and operable to communicate said Bluetooth compliant handset audio signals and Bluetooth compliant data signals according to the Bluetooth radio communications protocol, and
a cordless telephone base unit, further comprising:
a telephone line interface circuit for coupling to a telephone line;
a second Bluetooth circuit coupled to said telephone line interface and operable to convert between conventional telephony signals and Bluetooth compliant base unit audio signals, and
a second cordless telephone transceiver coupled to said Bluetooth circuit, and operable to communicate said Bluetooth compliant base unit audio signals according to the Bluetooth radio communications protocol, and wherein
said cordless telephone handset and said cordless telephone base unit communicate audio and data information according to the Bluetooth protocol.

10. The apparatus in claim 9, and wherein said serial communications port is a Universal Serial Bus compliant serial port.

11. The apparatus of claim 9, further comprising a software means executable on a separate computing device enabling the coupling of data signals between said separate computing device and said first Bluetooth circuit, though said serial port, for coupling said data signals via the Bluetooth radio communications protocol by said first cordless telephone transceiver.

12. The apparatus of claim 9, further comprising:
a memory for storing user data coupled to said first Bluetooth circuit, said first Bluetooth circuit operable to couple data signals with said memory, and
a software means executable on a separate computing device for synchronizing data stored in said separate computing device with user data stored in said memory via said serial port while said separate computing device is coupled to said serial port.
